(19) United States
(12) Patent Application Publication
(10) Pub. No.: US 2006/0043876 A1
(43) Pub. Date: Mar. 2, 2006

(54) Self-luminous planar display device and manufacturing method thereof

(76) Inventors: Yuuichi Kijima, Chosei (JP); Yoshiyuki Kaneko, Hachioji (JP); Takashi Fujimura, Mobara (JP)

Correspondence Address: Christopher E. Chalsen;Milbank, Tweed, Hadley & McCloy LLP, 1 Chase Manhattan Plaza, New York, NY, 10005-1413, US

(21) Appl. No.: 11/207,135

(22) Filed: Aug. 18, 2005

(30) Foreign Application Priority Data
Aug. 26, 2004 (JP) 2004-246814

(51) Int. Cl. H01J 63/04; H01J 1/62

(52) U.S. Cl. 313/496

(57) ABSTRACT

The present invention suppresses the generation of deterioration of degree of vacuum attributed to a chemical reaction between an insulation film and an adhesive agent for adhering a sealing frame. An insulation film formed between first electrodes and first electrode lead terminals and second electrodes and second electrode lead terminals on a back panel is formed except for a sealing region where the back panel and a face panel are sealed. In a second electrode lead terminal side of the sealing region, only an adhesive-agent layer which adheres the back panel and the sealing frame and the second electrode lead terminals are present between a sealing frame and a back substrate.

### BACKGROUND OF THE INVENTION

1. Field of the Invention

The present invention relates to a display device which makes use of the emission of electrons into a vacuum, and more preferably to a self-luminous planar display device which includes a display panel formed by sealing a back panel having electron sources for emitting electrons and a face panel having phosphor layers of a plurality of colors which emit lights when excited by electrons taken out from the back panel and electron accelerating electrodes using a sealing frame and a manufacturing method thereof.

2. Description of the Related Art

A color cathode ray tube has been popularly used conventionally as an excellent display device which exhibits high brightness and high definition. However, along with the realization of high image quality of recent information processing device and television broadcasting, there has been a strong demand for a planar display device which is light-weighted and requires a small space for installation while ensuring the excellent properties such as high brightness and high definition.

As typical examples of such a planar display device, a liquid crystal display device, a plasma display device or the like has been put into practice. Further, particularly with respect to the planar display device which can realize the high brightness, various types of panel display devices including an electron emission type display device which makes use of emission of electrons into a vacuum from electron sources, a field emission type display device, and an organic EL display which is characterized by low power consumption are expected to be put into practice in near future. Here, the plasma display device, the electron emission type display device or the organic EL display device which requires no auxiliary illumination light sources is referred to as a self-luminous planar display device.

Among these self-luminous planar display devices, with respect to the electron emission typed is play device, the display device which has the cone-shaped electron emission structure proposed by C. A. Spindt, a display device which has the metal-insulator-metal (MIM) type electron emission structure, a display device which has the electron emission structure making use of an electron emission phenomenon based on a quantum tunneling effect (also referred to as surface conductive type electron sources), and a display device which makes use of an electron emission phenomenon which a diamond film, a graphite film, nanotubes or the like as represented by carbon nanotubes and the like have been known.

A display panel which constitutes an electron emission type display device which is one example of the self-luminous planar display device includes a back panel which forms first electrodes (for example, cathode electrodes) having electron-emission-type electron sources on an inner surface thereof and second electrodes (for example, gate electrodes, scanning electrodes) which form control electrodes on an inner surface thereof, and a face panel which forms phosphor layers of plural colors and a third electrode (anode electrode, anode) on an inner surface thereof which faces the back panel. The face panel is made of a light transmitting material which is preferably glass. Further, a sealing frame is interposed between laminated inner peripheries of both panels and both panels are sealed to each other and, thereafter, an inside defined by the back panel, the face panel and the sealing frame is evacuated thus forming the display panel. In the back panel, on a back substrate which is preferably made of an insulating material such as glass, alumina or the like, a plurality of first electrodes which extend in the first direction and are arranged in parallel in the second direction which intersects the first direction and include a large number of electron sources and the second electrodes which extend in the second direction and are arranged in parallel in the first direction are formed.

Electron sources are provided in the vicinity of the intersecting portions between the first electrodes and the second electrodes and a quantity of electrons emitted from the electron sources (including turning on and off of the emission) is controlled based on the potential difference between the first electrode and the second electrode. The emitted electrons are accelerated by a high voltage applied to the anode formed over the face panel and impinge on phosphor layers formed over the face panel so as to excite the phosphor layers whereby the phosphor layers emit lights of colors which correspond to the light emitting properties of the phosphor layers.

Further, the sealing frame is fixed to inner peripheries of the back panel and the face panel using an adhesive material such as frit glass. The degree of vacuum in the inside defined by the back panel, the face panel and the sealing frame is set to, for example, 10⁻⁵ to 10⁻⁷. With respect to the self-luminous planar display device having a large display screen size, gap holding members (spacers) are interposed and fixed between the back panel and the face panel so as to hold the gap therebetween to a given distance.

Between the sealing frame and the back panel, first electrode lead terminals which are connected with the first electrodes formed over the back panel and second electrode lead terminals which are connected with the second electrodes are present. Usually, the sealing frame is fixed to the back panel and the face panel using the adhesive agent such as frit glass. The first lead terminals and the second lead terminals are pulled out through a sealing region which constitutes the adhesive portion which adheres the sealing frame and the back panel and vacuum leakage is liable to occur in this sealing region. An example of means to cope with such vacuum leakage is disclosed in Japanese Laid-open 2000-251778.

### SUMMARY OF THE INVENTION

An insulation film (also referred to as interlayer insulation film) which insulates between the first electrodes and the second electrodes exists in the above-mentioned sealing region. With respect to the insulation film (interlayer insulation film) which is interposed between the first electrodes (and the first electrode lead terminals) and the second electrodes (and the second electrode lead terminals), there has been known an insulation film which generates a chemical reaction with an adhesive agent such as frit glass which fixedly secures the sealing frame and promotes the vacuum leakage through the sealing region. As a typical example, when the insulation film uses silicon nitride (SiN) as a material thereof and frit glass (PbO system) is used for fixing the sealing frame, a reaction of PbO+SiN→Pb+SiO₂+NO (gas) is generated and the gas is confined in the frit glass as bubbles and hence, an adhered portion becomes fragile and the hermetic property of the adhered portion is lowered. As a result of lowering of the hermetic property, the degree of vacuum of the inner space defined by the back panel, the face panel and the sealing frame is deteriorated thus damaging the reliability of the self-luminous planar display device.

Accordingly, it is an object of the present invention to provide a highly reliable self-luminous planar display device which can suppress the generation of the deterioration of the degree of vacuum attributed to a reaction between an interlayer insulation film and an adhesive agent for a sealing frame and a manufacturing method of the self-luminous planar display device.

According to means 1 of the present invention for achieving the above-mentioned object, an insulation film (interlayer insulation film) which is interposed between first electrodes and first electrode lead terminals (hereinafter simply referred to as “first electrodes”) and second electrodes and second electrode lead terminals (hereinafter simply referred to as “second electrodes”) on a back panel is formed except for a sealing region with a face panel (the insulation film being not present in the sealing region). Further, on a second electrode lead side of the sealing region, between a sealing frame and the back panel, only an adhesive agent layer which adheres the back panel and the sealing frame and the second electrode lead terminals are present. Further, according to means 2 of the present invention, the interlayer insulation film remains below the second electrode lead terminals in the sealing region, and the interlayer insulation film does not exist between the second electrode lead terminals. Further, according to means 3 of the present invention, in the above-mentioned means 2, in leaving the interlayer insulation film below the second electrode lead terminals in the sealing region, the second electrode lead terminals are formed in a planar shape with a length of at least one side periphery thereof set longer than a lead distance of the second electrode lead terminals in the sealing region.

Here, also with respect to the first electrode lead side of the sealing region, by removing the interlayer insulation film in the sealing region in the same manner as the means 1, it is possible to obviate a contact of the adhesive agent for adhering the sealing frame and the interlayer insulation film.

By incorporating an image signal drive circuit, a scanning signal drive circuit and other peripheral circuits on the display panel having such a constitution, the self-luminous planar display device is constituted.

According to the means 1 of the present invention, the contact between the interlayer insulation film which insulates the first electrodes and the second electrodes and the adhesive agent which adheres the sealing frame to the back panel can be obviated and hence, the vacuum leakage attributed to a chemical reaction between the interlayer insulation film and the adhesive agent can be prevented whereby the vacuum leakage attributed to the contact can be prevented. Further, according to the means 2 of the present invention, contact portions of the interlayer insulation film which insulates the first electrodes and the second electrodes and the adhesive agent which adheres the sealing frame to the back panel are side surfaces of the interlayer insulation film which is present below the second electrodes (second electrode lead terminals) and hence, the chemical reaction between the interlayer insulation film and the adhesive agent occurs in an extremely limited level whereby the vacuum leakage attributed to the contact can be prevented. Further, according to the means 3 of the present invention, since a contact distance between the side surface of the interlayer insulation film and the adhesive agent which adheres the sealing frame can be elongated, it is possible to reduce the possibility of the vacuum leakage.

Here, in the means 1, by forming the second electrode lead terminals in a planar shape with a length of at least one side periphery thereof set longer than a lead distance of the second electrode lead terminals, it is possible to reduce the possibility of the vacuum leakage. It is needless to say that the above-mentioned constitution of the means 1 is applicable to the first electrodes (first electrode lead terminals) in the same manner.

### BRIEF DESCRIPTION OF THE DRAWINGS

FIG. 1A, FIG. 1B, FIG. 1C and FIG. 1D are schematic views for explaining an embodiment 1 of a display panel constituting a self-luminous planar display device of the present invention;

FIG. 2 is a view for explaining a manufacturing method of a back panel of the embodiment 1;

FIG. 3A, FIG. 3B, and FIG. 3C are schematic views for explaining an embodiment 2 of a display panel constituting the self-luminous planar display device of the present invention;

FIG. 4 is a view for explaining a manufacturing method of a back panel of the embodiment 2;

FIG. 5 is a schematic view of an essential part for explaining an embodiment 3 of a display panel constituting the self-luminous planar display device of the present invention;

FIG. 6 is a perspective view with a part in cross section for explaining one example of the entire structure of the self-luminous planar display device of the present invention;

FIG. 7 is a cross-sectional view taken along a line A-A′ in FIG. 6;

FIG. 8A, FIG. 8B and FIG. 8C are views for explaining one example of an electron source which constitutes a pixel of the self-luminous planar display device of the present invention; and

FIG. 9 is an explanatory view of an example of an equivalent circuit of an image display device to which the constitution of the present invention is applied.

### DESCRIPTION OF THE PREFERRED EMBODIMENTS

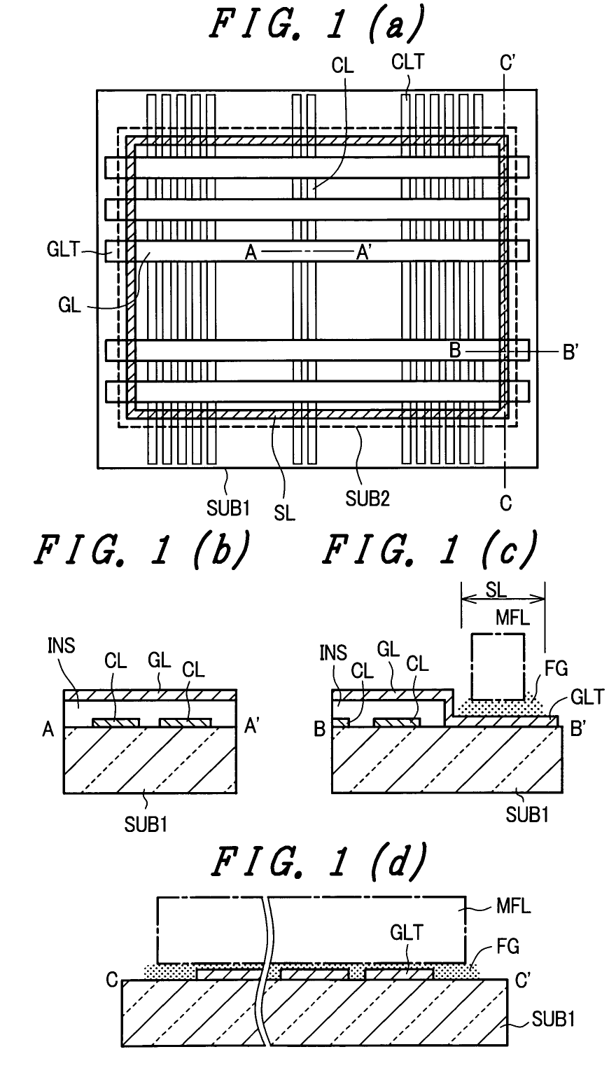

Embodiments of the present invention are explained in detail in conjunction with attached drawings hereinafter. First of all, an embodiment 1 of the present invention is explained in conjunction with FIG. 1.

### Embodiment 1

FIG. 1A, FIG. 1B, FIG. 1C and FIG. 1D are schematic views for explaining an embodiment 1 of a display panel constituting a self-luminous planar display device of the present invention, wherein FIG. 1A is a plan view for explaining the inner surface constitution of a back panel, FIG. 1B is a partial cross-sectional view taken along a line A-A′ in FIG. 1A, FIG. 1C is a partial cross-sectional view taken along a line B-B′ in FIG. 1A, and FIG. 1D is a partial cross-sectional view taken along a line C-C′ in FIG. 1A. Here, in a plan view of FIG. 1A, a position of a profile of a substrate (face substrate) SUB2 of a face panel is indicated by a broken line. The back panel and the face panel allow a sealing frame MFL to be interposed between inner brims of outer peripheries thereof. The back panel, the face panel and the sealing frame MFL are adhered to each other and are integrally formed using frit glass FG. A sealing region on the sealing frame MFL is indicated by symbol SL.

With respect to the back panel, on a back substrate SUB1, first electrodes C and second electrodes GL are formed. In FIG. 1A, first electrode lead terminals CLT are formed over end portions of the first electrodes CL, while second electrode lead terminals GLT are formed over end portions of the second electrodes GL. In the embodiment explained hereinafter, the explanation is made hereinafter by setting the first electrodes CL as cathode electrodes CL, the first electrode lead terminals CLT as cathode electrode lead terminals CLT, the second electrodes GL as gate electrodes GL, and the second electrode lead terminals GLT as gate electrode lead terminals GLT.

The cathode electrodes CL are formed of a strip-shaped electrode, wherein a large number of cathode electrodes CL extend in the first direction (longitudinal direction in the drawing)and are arranged in parallel in the second direction (lateral direction in the drawing) which crosses the first direction on the back substrate SUB1. An insulation film (interlayer insulation film) INS is formed in a state that the insulation film INS covers the cathode electrodes CL from above. Over the insulation film INS, a large number of gate electrodes GL extend in the second direction and are arranged in parallel in the first direction. The gate electrodes GL are also formed of a strip-shaped electrode. The cathode electrode lead terminals CLT are formed over end portions of the cathode electrodes CL. In FIG. 1A, the cathode electrode lead terminals CLT are formed over both ends of the cathode electrodes CL, the cathode electrode lead terminals CLT may be formed over either one of these ends.

In the same manner, the gate electrode lead terminals GLT are formed over end portions of the gate electrodes GL. Although the gate electrode lead terminals GLT are formed over both ends of each gate electrode GL, the gate electrode GL may be formed over only one of each gate electrode GL.

A display region is formed inside a sealing region SL and electron sources are arranged at respective intersecting portions of the cathode electrodes CL and the gate electrodes GL in the inside of the display region. The electron sources are, for example, formed of an MIM electron source which has the constitution described later. Here, the electron source emits a quantity of electrons corresponding to an image data signal supplied from the cathode electrode lead terminal CLT to the cathode electrode CL which intersects the gate electrode GL selected in response to a vertical scanning signal sequentially inputted from the gate electrode lead terminal GLT.

The stacked structure of the cathode electrodes CL and the gate electrodes GL in the display region is shown in FIG. 1B. Here, FIG. 1B is a schematic view and the electron sources are omitted from the drawing. The cathode electrodes CL are formed over the back substrate SUB1 and the interlayer insulation film INS is formed in a state that the interlayer insulation film INS covers the cathode electrodes CL from above. In the embodiment 1, silicon nitride (SiN) is used as a material of the Interlayer insulation film INS. Here, as the interlayer insulation film, a single-layered vapor deposition film formed of a silicon oxide film, a multi-layered vapor deposition film formed of a silicon nitride film and a silicon oxide film or common vapor deposition film in which silicon nitride and silicon oxide are mixed may be used. The gate electrodes GL are formed over the interlayer insulation film INS. End portions of the gate electrodes GL form the gate electrode lead terminals GLT and these gate electrode lead terminals GLT are pulled out to the outside of the sealing region SL.

The interlayer insulation film INS is, as show in FIG. 1C, formed more inside than the sealing region SL and is arranged not to be in contact with an adhesive agent FG which adheres the sealing frame MFL to the back substrate SUB1. In this embodiment 1, as the adhesive agent FG, frit glass containing lead oxide (PbO) is used. As shown in FIG. 1D, on the gate electrode lead terminal sides (both left and right sides in FIG. 1A) between the back substrate SUB1 which constitutes the back panel and the sealing frame MFL, the gate electrode lead terminals GLT and the adhesive agent FG are interposed.

By adopting the constitution of the embodiment 1, there is no space or possibility that the above-mentioned chemical reaction of PbO+SiN→Pb+SiO₂+NO is generated and hence, it is possible to completely avoid the contact between the interlayer insulation film INS and the adhesive agent FG which adheres the sealing frame MFL to the back panel whereby the vacuum leakage attributed to the chemical reaction between both members can be prevented. Accordingly, the vacuum leakage in the sealing region can be reduced and hence, it is possible to provide the highly reliable self-luminous planar display device.

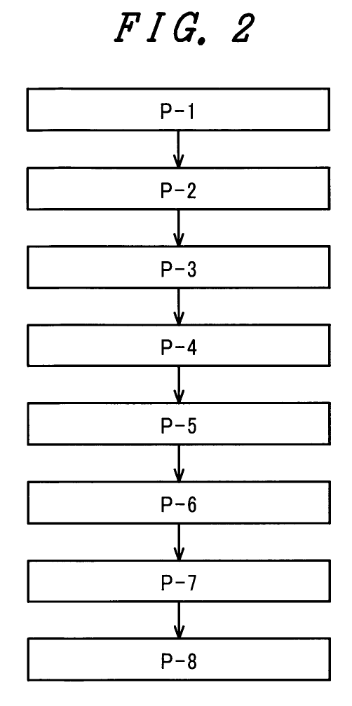

FIG. 2 is a view for explaining a manufacturing method of the back panel of the embodiment 1. Hereinafter, the explanation is made in order of manufacturing steps (expressed such as P-1). First of all, a first electrode film is formed over a whole surface of the back substrate by vapor-depositing metal (aluminum or the like) (P-1). In the embodiment 1, the first electrodes constitute cathode electrodes and may also constitute the cathode electrode lead terminals. A photosensitive resist is applied to the back substrate in a state that the photosensitive resist covers the first electrode film and is dried and, thereafter, patterning is performed using a photolithography technique in which the exposure is made using a photo mask having a pattern of the cathode electrodes and the cathode electrode lead terminals and the developing processing is performed, whereby the first electrode film is exposed except for portions which become the cathode electrodes and the cathode electrode lead terminals (P-2).

By dissolving and removing the first electrode film at portions exposed from the photosensitive resist by wet etching, the cathode electrodes and the cathode electrode lead terminals are formed (P-3). Thereafter, the residual photosensitive resist is removed and cleaned using a peel-off agent or by washing with water.

An insulation film (becoming interlayer insulation film) is formed in a state that the insulation film covers a whole surface of the formed cathode electrodes and cathode electrode lead terminals and the inside of the sealing region (seal region) which is sealed on both left and right sides of the sealing frame shown in FIG. 1A (P-4). As such an insulation film, a silicon nitride (SiN) film is used and is formed by vapor deposition by masking both left and right sides of the sealing region as viewed in FIG. 1A.

A second electrode film is formed by vapor deposition of metal (aluminum or the like) in a state that the second electrode film covers a whole surface of the back substrate on which the insulation film is formed (also covering the cathode electrodes and the cathode electrode lead terminals) (P-5). In the embodiment 1, the second electrodes constitute the gate electrodes and also may constitute the gate electrode lead terminals.

A photosensitive resist is applied to the back substrate in a state that the photosensitive resist covers the second metal film formed in the above-mentioned manner and is dried and, thereafter, patterning is performed using a photolithography technique in which the exposure is made using a photo mask having a pattern of the gate electrodes and the gate electrode lead terminals and the developing processing is performed, whereby the second electrode film is exposed except for portions which become the gate electrodes and the gate electrode lead terminals (P-6).

By dissolving and removing the second electrode film at portions exposed from the photosensitive resist by wet etching, the gate electrodes and the gate electrode lead terminals are formed (P-7). Thereafter, the residual photosensitive resist is removed and cleaned using a peel-off agent or by washing with water.

Thereafter, the interlayer insulation film on the cathode electrode lead terminal sides (both upper and lower sides in FIG. 1A) of the sealing region, the cathode electrode lead terminal region and the electron source portions is removed (P-8). The interlayer insulation film is not present on the gate electrode lead terminal sides (both left and right sides in FIG. 1A) of the sealing region due to the mask vapor deposition and hence, only the gate electrode lead terminals and the adhesive agent are present between the back substrate and the sealing frame. The face panel is laminated to the back panel manufactured in this manner by way of the sealing frame and, thereafter, the vacuum evacuation is performed to complete the display panel which constitutes the self-luminous planar display device.

### Embodiment 2

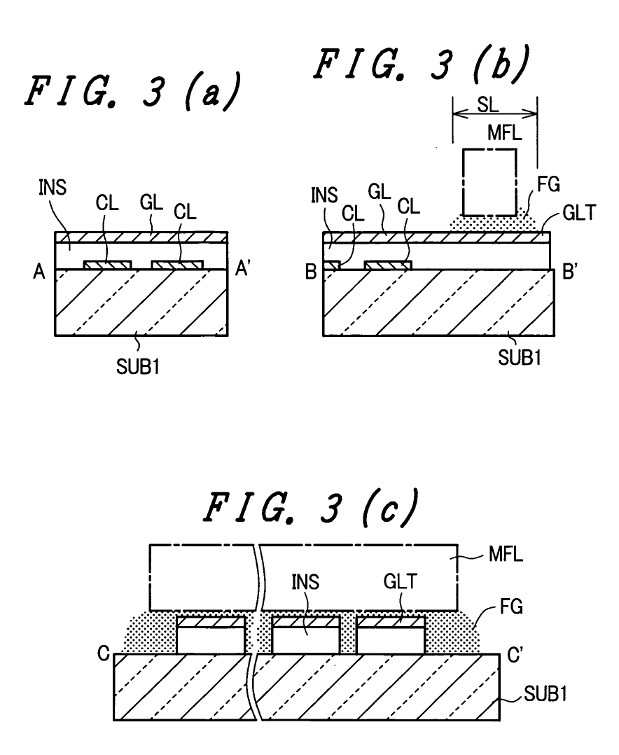

FIG. 3A, FIG. 3B and FIG. 3C are schematic views for explaining an embodiment 2 of a display panel constituting the self-luminous planar display device of the present invention, and also are views for explaining the inner surface constitution of a back panel. Here, a plan view of the back panel of the embodiment 2 is substantially equal to FIG. 1A. FIG. 3A is a partial cross sectional view taken along a line A-A′ in FIG. 1A, FIG. 3B is a partial cross-sectional view taken along a line B-B′ in FIG. 1A and FIG. 3C is a partial cross-sectional view taken along a line C-C′ in FIG. 1A. In the embodiment 2, the sealing frame MFL is interposed between inner brims of outer peripheries of the back panel and the face panel, and the sealing frame MFL is adhered to and integrally formed with the back panel and the face panel using frit glass FG as an adhesive agent. A sealing region in the sealing frame MFL is indicated by symbol SL.

In the same manner as the embodiment 1, on the back substrate SUB1, cathode electrodes CL and gate electrodes GL are formed. The cathode electrode lead terminals CLT are formed over end portions of the cathode electrodes CL, while gate electrode lead terminals GLT are formed over end portions of the gate electrodes GL. The cathode electrodes CL are formed of a stripe-shaped electrode, wherein a large number of cathode electrodes CL extend in the first direction and are arranged in parallel in the second direction which intersects the first direction over the back substrate SUB1. An insulation film (interlayer insulation film) INS is formed in a state that the insulation film covers the cathode electrodes CL from above. A large number of gate electrodes GL which extend in the second direction and are arranged in parallel in the first direction are formed over the insulation film INS. The gate electrodes GL are also formed of a stripe-shaped electrode. The planar arrangement is substantially equal to the planar arrangement shown in FIG. 1A.

The stacked structure of the cathode electrodes CL and the gate electrodes GL in the display region of the embodiment 2 is shown in FIG. 3A. Here, electron sources are omitted from the drawing. The cathode electrodes CL are formed over the back substrate SUB1 and the interlayer insulation film INS is formed in a state that the interlayer insulation film INS covers the cathode electrodes CL from above. In the embodiment 2, silicon nitride (SiN) is used as a material of the interlayer insulation film INS. Here, as the interlayer insulation film, a single-layered vapor deposition film formed of a silicon oxide film, a multi-layered vapor deposition film formed of a silicon nitride film and a silicon oxide film or common vapor deposition film in which silicon nitride and silicon oxide are mixed may be used. The gate electrodes GL are formed over the interlayer insulation film INS. End portions of the gate electrodes GL form the gate electrode lead terminals GLT and these gate electrode lead terminals GLT are pulled out to the outside of the sealing region SL.

The interlayer insulation film INS is, as shown in FIG. 3B and FIG. 3C, provided only below the gate electrode lead terminals GLT in the sealing region SL. The interlayer insulation film INS brings only side surfaces thereof disposed below the gate electrode lead terminals GLT into contact with the adhesive agent FG which adheres the sealing frame MFL in the sealing region SL. In this embodiment 2, frit glass containing lead oxide (PbO) is used as the adhesive agent FG. As shown in FIG. 3C, on the gate electrode lead terminal sides (both left and right sides in FIG. 1A) between the back substrate SUB1 which constitutes the back panel and the sealing frame MFL, the gate electrode lead terminals GLT, the interlayer insulation film INS which remains below the gate electrode lead terminals GLT and the adhesive agent FG are interposed.

By adopting the constitution of the embodiment 2, although there exists a possibility that the above-mentioned chemical reaction of PbO+SiN→Pb+SiO₂+NO is generated only on the side surfaces of the interlayer insulation film INS below the gate electrode lead terminals GLT, a contact area of such portions is extremely small and hence, even when the chemical reaction is generated between both members, the chemical reaction is trivial whereby the possibility of the vacuum leakage is extremely small. Accordingly, it is possible to provide the highly reliable self-luminous planar display device.

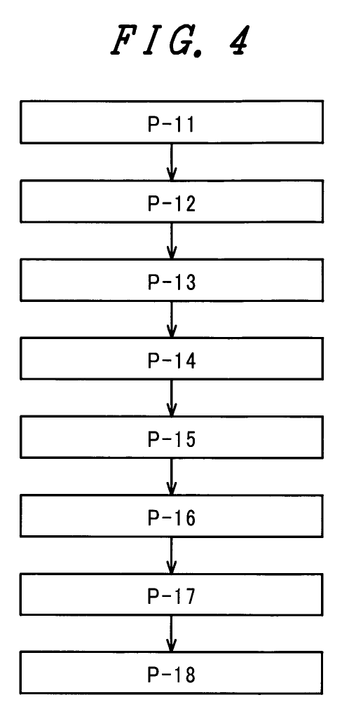

FIG. 4 is a view for explaining a manufacturing method of the back panel of the embodiment 2. Hereinafter, the explanation is made in order of manufacturing steps. First of all, a first electrode film is formed over a whole surface of the back substrate by vapor-depositing metal (aluminum or the like) (P-11). Also in the embodiment 2, the first electrodes constitute cathode electrodes and may also constitute the cathode electrode lead terminals. A photosensitive resist is applied to cover the first electrode film and is dried and, thereafter, patterning is performed using a photolithography technique in which the exposure is made using a photo mask having a pattern of the cathode electrodes and the cathode electrode lead terminals and the developing processing is performed, whereby the first electrode film is exposed except for portions which become the cathode electrodes and the cathode electrode lead terminals (P-12).

By dissolving and removing the first electrode film at portions exposed from the photosensitive resist by wet etching, the cathode electrodes and the cathode electrode lead terminals are formed (P-13). Thereafter, the residual photosensitive resist is removed and cleaned using a peel-off agent or by washing with water.

An insulation film (becoming an interlayer insulation film) is formed over a whole surface of the cathode electrodes and the cathode electrode lead terminals formed in the above-mentioned manner and to ends of the back substrate exceeding the sealing region (seal region) which is sealed by the sealing frame (P-14). A silicon nitride (SiN) film is used as such an insulation film.

A second electrode film is formed by vapor deposition of metal (aluminum or the like) in a state that the second electrode film covers a whole surface of the back substrate on which the insulation film is formed (also covering the cathode electrodes and the cathode electrode lead terminals) (P-15). Also in the embodiment 2, the second electrodes constitute the gate electrodes and also may constitute the gate electrode lead terminals.

A photosensitive resist film is applied to cover the second metal film formed in the above-mentioned manner and is dried and, thereafter, patterning is performed using a photolithography technique in which the exposure is made using a photo mask having a pattern of the gate electrodes and the gate electrode lead terminals and, thereafter, the developing processing is performed, whereby the second electrode film is exposed except for portions which become the gate electrodes and the gate electrode lead terminals (P-16).

By dissolving and removing the second electrode film at portions exposed from the photosensitive resist by wet etching, the gate electrodes and the gate electrode lead terminals are formed (P-17). Thereafter, the residual photosensitive resist is removed and cleaned using a peel-off agent or by washing with water.

Thereafter, the interlayer insulation film at sealing region (including the sealing region between the gate electrode lead terminals) which is sealed by the sealing frame, the electron sources and the first electrode lead terminal portions is removed (P-18). Accordingly, in the sealing region, the interlayer insulation film is present only below the gate electrode lead terminals. Then, the back panel manufactured in this manner is laminated to the face panel by way of the sealing frame and, thereafter, the vacuum evacuation is performed to complete the display panel which constitutes the self-luminous planar display device.

### Embodiment 3

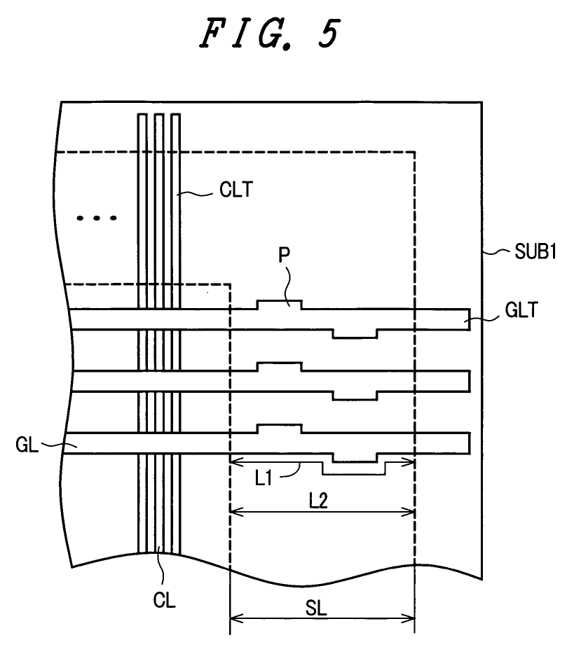

FIG. 5 is a schematic view of an essential part for explaining an embodiment 3 of the display panel which constitutes the self-luminous planar display device of the present invention and also is a plan view of gate electrode lead terminals and a portion of a sealing frame of a back panel. The embodiment 3 adopts the structure of the embodiment 2 as the basic constitution thereof, wherein the gate electrode lead terminal GLT in a sealing region SL is formed in an elongated planar shape in which a length of one side periphery of the gate electrode lead terminal GLT is set longer than a lead distance of the gate electrode lead terminal GLT in the sealing region. An interlayer insulation film which is interposed below the gate electrode lead terminal GLT is present having a planar shape which follows a planar shape of the gate electrode lead terminal GLT.

In FIG. 5, projections P are formed over side peripheries of the second electrode lead terminal GLT in the sealing region SL. Due to such a constitution, a length L1 of the side periphery of the second electrode lead terminal GLT in the sealing region SL (also equal to a length of the interlayer insulation film INS disposed below the second electrode lead terminal GLT) is set longer than a lead length L2 of the second electrode lead terminal GLT in the sealing region SL. Accordingly, a contact distance between the interlayer insulation film INS and an adhesive agent FG which adheres a sealing frame MFL to the back panel is also elongated in the same manner. As a result, a possibility that the vacuum leakage is generated can be reduced.

Here, the shape of electrode which allows the length L1 of the side periphery of the second electrode lead terminal GLT in the sealing region SL to become longer than the lead length L2 of the second electrode lead terminal GLT in the sealing region SL is not limited to the shape shown in FIG. 5 and the electrodes may be formed in other proper shapes such as a bent shape, a zigzag shape or other amorphous shape. Further, these electrode shapes are applicable to not only the gate electrode lead terminal and is also applicable to the cathode electrode lead terminals.

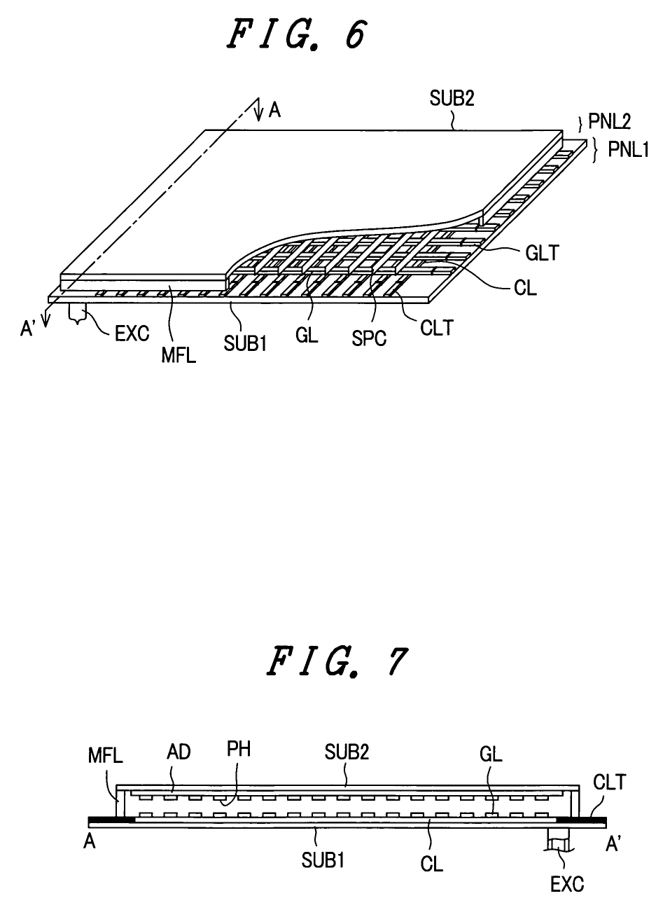

FIG. 6 is a perspective view with a part broken away for explaining one embodiment of the whole structure of the self-luminous planar display device according to the present invention. Further, FIG. 7 is a cross-sectional view taken along a line A-A′ in FIG. 6. On the inner surface of the back substrate SUB1 which constitutes the back panel, the cathode electrodes CL and the gate electrodes GL are formed, and electron sources are formed over the intersecting portions of the cathode electrodes CL and the gate electrodes GL. The cathode electrode lead lines CLT are formed over end portions of the cathode electrodes CL, while the gate electrode lead lines GLT are formed over end portions of the gate electrodes GL.

On an inner surface of the face substrate SUB2 which constitutes the face panel, an anode AD and phosphor layers PH are formed. The back substrate SUB1 which constitutes the back panel PNL1 and the face substrate SUB2 which constitutes the face panel PNL2 are laminated to each other while interposing the sealing frame MFL between the peripheries thereof. To hold a laminated gap to a given value, partition walls SPC which are preferably made of a glass plate are provided in an erected manner between the back panel PNL1 and the face panel PNL2. FIG. 7 is a view which shows a cross section taken along the partition wall SPC and hence, the partition walls SPC are omitted from the drawing.

Here, the inner space hermetically sealed by the back panel PNL1, the face panel PNL2 and the sealing frame MFL is evacuated through an exhaust pipe EXC formed in a portion of the back panel PNL1 to create a given vacuum state in the inner space.

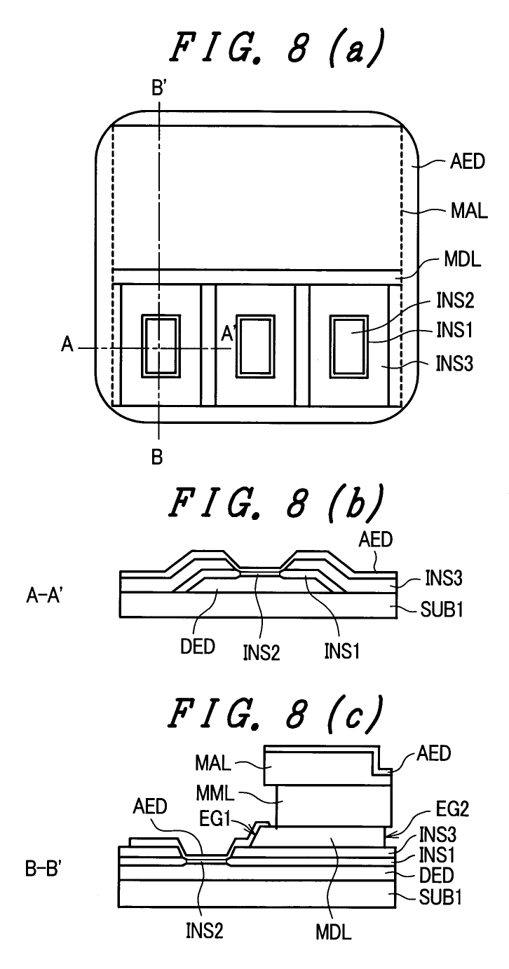

FIG. 8A, FIG. 8B and FIG. 8C are views for explaining one example of electron source which constitutes a pixel of the self-luminous planar display device of the present invention, wherein FIG. 8A is a plan view, FIG. 8B is a cross-sectional view taken along a line A-A′ in FIG. 8A, and FIG. 8C is a cross-sectional view taken along a line B-B′ in FIG. 8A. Here, the electron source is formed of an MIM electron source.

The structure of the electron source is explained in conjunction with the manufacturing steps thereof. First of all, on the back substrate SUB1, a lower electrode DED (the cathode electrode CL in the above-mentioned respective embodiments), a protective insulation layer INS1 and an insulation layer INS2 are formed. Next, an interlayer insulation film INS3 and metal films which form an upper bus electrode constituting a current supply line to an upper electrode AED (the gate electrode GL in the above-mentioned respective embodiments)and a spacer electrode for arranging a spacer are formed by a sputtering method or the like, for example. Although aluminum may be used as a material of the lower electrode and the upper electrode, other metals described later can be also used as the material of the lower electrode and the upper electrode.

The interlayer insulation film INS3 may be made of silicon oxide, silicon nitride or silicon, for example. Here, silicon nitride is used as the material of the interlayer insulation film INS3 and a thickness of the interlayer insulation film INS3 is set to 100 nm. The interlayer insulation film INS3, when a pin hole is formed in the protective insulation layer INS1 which is formed by anodizing, embeds a cavity and plays a role of keeping the insulation between the lower electrode DED and the upper bus electrode (a three-layered stacked film which sandwiches copper (Cu) forming a metal-film intermediate layer MML between a metal-film lower layer MDL and a metal-film upper layer MAL) which constitutes the scanning line.

Here, the upper bus electrode is not limited to the above-mentioned three-layered stacked film and the number of layers can be increased more than three layers. For example, as the metal-film lower layer MDL and the metal-film upper layer MAL, a film made of a metal material having high oxidation resistance such as aluminum (Al), chromium (Cr), tungsten (W), molybdenum (Mo) or the like, an alloy of these material or a stacked film made of these materials can be used. Here, in this embodiment, an aluminum-neodymium (Al—Nd) alloy is used as the metal-film lower layer MDL and the metal-film upper layer MAL. Besides these materials, with the use of a five-layered film which uses a stacked film formed of an Al alloy film and a Cr film, a W film, a Mo film as the metal-film lower layer MDL, a stacked film formed of a Cr film, a W film, a Mo film and an Al alloy film as the metal-film upper layer MAL and uses high-melting-point metal as a film which is brought into contact with Cu in the metal-film intermediate layer MML, during the heating step in the manufacturing process of the image display device, the high-melting-point metal forms a barrier film so that the alloying of Al and Cu can be suppressed and this suppression of alloying is particularly effective in reducing the resistance of the wiring.

When only the Al—Nd alloy film is used as the above-mentioned metal-film lower layer MDL or metal-film upper layer MAL, with respect to a film thickness of the Al—Nd alloy film, a thickness of the metal-film upper layer MAL is set larger than a thickness of the metal-film lower layer MDL, while a thickness of the Cu film which constitutes the metal-film intermediate layer MML is increased as much as possible to reduce the wiring resistance. Here, the film thickness of the metal-film lower layer MDL is set to 300 nm, the film thickness of the metal-film intermediate layer MML is set to 4 μm, and the film thickness of the metal-film upper layer MAL is set to 450 nm. Here, the Cu film which constitutes the metal-film intermediate layer MML can be formed by electroplating besides sputtering.

In forming the above-mentioned five-layered film using the high-melting-point metal, in the same manner as the Cu film, it is particularly effective to use a stacked film which sandwiches the Cu film with Mo films which can be etched by wet etching using a mixed aqueous solution of phosphoric acid, acetic acid and nitric acid as the metal film intermediate layer MML. In this case, a film thickness of the Mo films which sandwich the Cu film is set to 50 nm, a film thickness of the AL alloy film which forms the metal-film lower layer MDL for sandwiching the metal-film intermediate layer is set to 300 nm, and a film thickness of the AL alloy film which forms the metal-film upper layer MAL for sandwiching the metal-film intermediate layer is set to 450 nm.

Subsequently, due to the patterning of resist by screen printing and etching, the metal-film upper layer MAL is formed in a stripe shape which intersects the lower electrodes DED. The etching is performed by wet etching using a mixed aqueous solution of, for example, phosphoric acid and acetic acid. Since the etchant does not contain nitric acid, it is possible to selectively etch only the Al—Nd alloy film without etching the Cu film.

Also in forming the five-layered film using Mo, using the etchant which does not contain nitric acid, it is possible to selectively etch only the Al—Nd alloy film without etching the Mo film and the Cu film. Here, although one metal-film upper layer MAL is formed per one pixel, it is also possible to form two metal-film upper layers MAL per one pixel.

Subsequently, using the same resist film as it is or using the Al—Nd alloy film on the metal-film upper layer MAL as a mask, the Cu film of the metal-film intermediate layer MML is etched by wet etching using a mixed aqueous solution of phosphoric acid, acetic acid and nitric acid. Since an etching rate of Cu in the mixed aqueous solution of phosphoric acid, acetic acid and nitric acid is sufficiently fast compared to an etching rate of the Al—Nd alloy film, it is possible to selectively etch only the Cu film of the metal-film intermediate layer MML. Also in forming the five-layered film using Mo, since etching rates of Mo and Cu are sufficiently fast compared to the etching rate of the Al—Nd alloy film, it is possible to selectively etch only the three-layered stacked film formed of the Mo films and the Cu film. In etching the Cu film, an ammonium persulfate aqueous solution and a sodium persulfate aqueous solution are effectively used besides the above-mentioned aqueous solution.

Subsequently, due to the patterning of resist by screen printing and etching, the metal-film lower layer MDL is formed in a stripe shape which intersects the lower electrodes DED. The etching is performed by wet etching using a mixed aqueous solution of phosphoric acid and acetic acid. Here, by shifting the printing resist film from the position of the stripe electrodes of the metal-film upper layer MAL, one-side end portion EG1 of the metal-film lower layer MDL is allowed to project from the metal-film upper layer MAL thus forming a contact portion which ensures the connection with the upper electrode AED in a later step. Further, to another-side end portion EG2 opposite to one-side end portion EG1 of the metal-film lower layer MDL, over-etching is performed using the metal-film upper layer MAL and the metal-film intermediate layer MML as a mask and a retracted portion is formed such that an eaves is formed over the metal-film intermediate layer MML.

Using the eaves of the metal-film intermediate layer MML, the upper electrode AED formed in the later stage is separated. Here, since a thickness of the metal-film upper layer MAL is larger than a thickness of the metal-film lower layer MDL, even when the etching of the metal-film lower layer MDL is finished, it is possible to leave the metal-film upper layer MAL on the Cu film of the metal-film intermediate layer MML. Accordingly, it is possible to protect the surface of the Cu film. Accordingly, even when Cu is used, it is possible to ensure the oxidation resistance, the upper electrode AED can be separated in a self-aligning manner, and it is possible to form the upper bus electrode which constitutes the scanning signal line which performs the supply of an electric current. Further, with respect to the five-layered metal-film intermediate layer MML which sandwiches the Cu film with Mo films, even when the Al alloy film of the metal-film upper layer MAL is thin, Mo suppresses the oxidation of Cu and hence, it is not always necessary to set the film thickness of the metal-film upper layer MAL larger than the film thickness of the metal-film lower layer MDL.

Subsequently, the interlayer film INS3 is formed to open an electron emitting portion. The electron emitting portion is formed in a portion of an intersecting portion of a space which is sandwiched between one lower electrode DED in the inside of the pixel and two upper bus electrodes (the stacked film formed of the metal-film lower layer MDL, the metal-film intermediate layer MML and the metal-film upper layer MAL and the stacked film formed of the metal-film lower layer MDL, the metal-film intermediate layer MML and the metal-film upper layer MAL of the neighboring pixel not shown in the drawing) which intersect the lower electrode DED. The etching can be performed by dry etching which uses an etchant gas containing CF₄ and SF₆, for example, as main components.

Finally, the upper electrode AED is formed as a film. In forming the upper electrode AED, a sputtering method is used. As the upper electrode AED, an aluminum film may be used. Further, a stacked film formed of, for example, an iridium (Ir) film, a platinum (Pt) film and a gold (Au) film is used, wherein a film thickness is set to 6 nm. Here, in the upper electrode AED, one end portion (the right side in FIG. 8C) of the upper bus electrode (the stacked film formed of the metal-film lower layer MDL, the metal-film intermediate layer MML, the metal-film upper layer MAL) is cut at the retracting portion (EG2) of the metal-film lower layer MDL formed by the eaves structure of the metal-film intermediate layer MML and the metal-film upper layer MAL. Then, at another end portion (the left side in FIG. 8C) of the upper bus electrode, the upper electrode AED is continuously formed with the upper bus electrode (the stacked film formed of the metal-film lower layer MDL, the metal-film intermediate layer MML, the metal-film upper layer MAL) by way of the contact portion (EG1) of the metal-film lower layer MDL without breaking thus allowing the supply of electric current to the electron emitting portion.

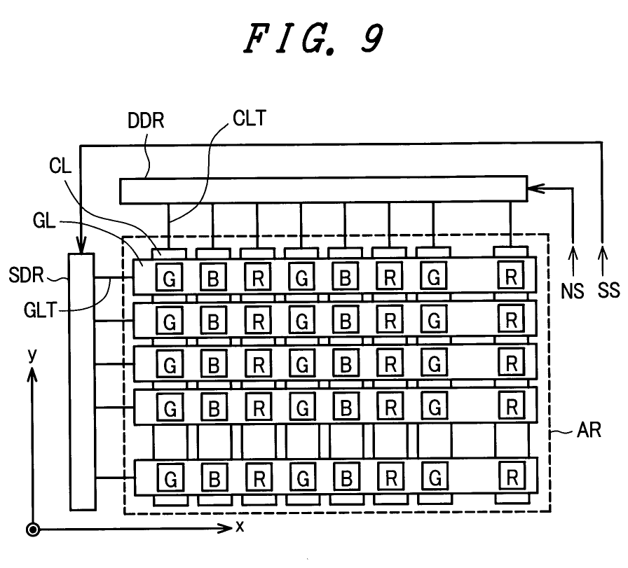

FIG. 9 is an explanatory view of an example of an equivalent circuit of an image display device to which the constitution of the present invention is applied.

A region depicted by a broken line in FIG. 9 indicates a display region AR. In the display region AR, n pieces of cathode electrodes CL and m pieces of gate electrodes GL are arranged in a state that these electrodes intersect each other thus forming pixels which are arranged in a matrix array of n×m. Sub pixels are formed over the respective intersecting portions of the matrix and one group consisting of three unit pixels (or sub pixels) “R”, “G”, “B” in the drawing constitutes one color pixel. Here, the constitution of the electron sources is omitted. The cathode electrodes CL are connected to the image signal drive circuit DDR through the cathode electrode lead terminals CLT, while the gate electrodes GL are connected to the scanning signal drive circuit SDR by way of the gate electrode lead terminals GLT. The image signal NS is inputted to the image signal drive circuit DDR from an external signal source, while the scanning signal SS is inputted to the scanning signal drive circuit SDR in the same manner.

Due to such a constitution, by supplying the image signal to the cathode electrodes CD which intersect the gate electrode GL which are sequentially selected, it is possible to display a two-dimensional full color image. With the use of the display panel having the above-mentioned constitutional example, a self-luminous planar display device which is operated at a relatively low voltage with high efficiency can be realized.

What is claimed is:

1. A self-luminous planar display device including a display panel, the display panel comprising:
a back panel which forms a display region including a large number of first electrodes which extend in the first direction and are arranged in parallel in the second direction which intersects the first direction, an insulation film which is formed to cover the first electrodes, a large number of second electrodes which extend in the second direction and are arranged in parallel in the first direction over the insulation film, and a large number of pixels having electron sources which are formed in the vicinity of intersecting portions between the first electrodes and the second electrodes;
a face panel which forms phosphor layers of plural colors which emit lights when excited by electrons taken out from the electron sources formed over the display region of the back panel and a third electrode on a face substrate; and
a sealing frame which is interposed between peripheral portions of the back panel and the face panel and seals both panels, wherein
at least one end of the first electrode includes a first electrode lead terminal which is pulled out to the outside from the display region through a sealing region where the back panel and the sealing frame face each other in an opposed manner,
at least one end of the second electrode includes a second electrode lead terminal which is pulled out to the outside from the display region through the sealing region where the back panel and the sealing frame face each other in an opposed manner, and
the insulation film is formed except for the sealing region attributed to the sealing frame.

2. A self-luminous planar display device according to claim 1, wherein the insulation film is formed of a single-layered vapor deposition film formed of either a silicon nitride film or a silicon oxide film or a multi-layered vapor deposition film formed of the silicon nitride film and the silicon oxide film.

3. A self-luminous planar display device according to claim 1, wherein the insulation film is formed of a common vapor deposition film in which silicon nitride and silicon oxide are mixed.

4. A self-luminous planar display device according to claim 1, wherein one or a plurality of partition walls which holds a given distance between the back panel and the face panel are provided between the back panel and the face panel and, at the same time, inside the sealing frame.

5. A self-luminous planar display device including a display panel, the display panel comprising:
a back panel which forms a display region including a large number of first electrodes which extend in the first direction and are arranged in parallel in the second direction which intersects the first direction, an insulation film which is formed to cover the first electrodes, a large number of second electrodes which extend in the second direction and are arranged in parallel in the first direction over the insulation film, and a large number of pixels having electron sources which are formed in the vicinity of intersecting portions between the first electrodes and the second electrodes;
a face panel which forms phosphor layers of plural colors which emit lights when excited by electrons taken out from the electron sources formed over the display region of the back panel and a third electrode on a face substrate; and
a sealing frame which is interposed between peripheral portions of the back panel and the face panel and seals both panels, wherein
at least one end of the first electrode includes a first electrode lead terminal which is pulled out to the outside from the display region through a sealing region where the back panel and the sealing frame face each other in an opposed manner,
at least one end of the second electrode includes a second electrode lead terminal which is pulled out to the outside from the display region through a sealing region where the back panel and the sealing frame face each other in an opposed manner, and
the insulation film is formed on a second electrode lead side of the sealing region attributed to the sealing frame except for spaces defined between the second electrode lead terminals.

6. A self-luminous planar display device according to claim 5, wherein the insulation film is formed of a single-layered vapor deposition film formed of either a silicon nitride film or a silicon oxide film or a multi-layered vapor deposition film formed of the silicon nitride film and the silicon oxide film.

7. A self-luminous planar display device according to claim 5, wherein the insulation film is formed of a common vapor deposition film in which silicon nitride and silicon oxide are mixed.

8. A self-luminous planar display device according to claim 5, wherein one or a plurality of partition walls which hold a given distance between the back panel and the face panel are provided between the back panel and the face panel and, at the same time, inside the sealing frame.

9. A self-luminous planar display device according to claim 5, wherein in the sealing region, the second electrode lead terminal has a planar shape in which a length of at least one side periphery of the second electrode lead terminal is set longer than a lead distance of the second electrode lead terminal in the sealing region.

10. A manufacturing method of a self-luminous planar display device which includes a display panel comprising;
a back panel which forms a large number of first electrodes which extend in the first direction and are arranged in parallel in the second direction which intersects the first direction and a large number of second electrodes which extend in the second direction and are arranged in parallel in the first direction on a back substrate;
a face panel which forms phosphor layers on a face substrate;
a sealing frame which seals the back panel and the face panel;
first electrode lead terminals which are pulled out to the outside from the first electrodes through a sealing region where the back substrate and the sealing frame face each other in an opposed manner; and
second electrode lead terminals which are pulled out to the outside from the second electrodes through the sealing region where the back substrate and the sealing frame face each other in an opposed manner; wherein
the manufacturing method comprises at least:
a first metal film forming step in which a first metal film is formed for forming the first electrodes and the first electrode lead terminals on the back substrate which constitutes the back panel;
a patterning step in which a photosensitive resist is applied to the formed first metal film and exposed portions of the first metal film are formed by exposure and developing processing of a pattern of the first electrodes and the first electrode lead terminals;
an etching processing step in which the exposed portions of the first metal film are etched and the photosensitive resist is removed after etching thus forming the first electrodes and the first electrode lead terminals;
an insulation film forming step in which an insulation film is formed in a state that an insulation film covers the first electrodes and the first electrode lead terminals and the insulation film is formed inside a sealing region which is sealed by a second electrode lead side of the sealing frame;
a second metal film forming step in which a second metal film is formed over the back substrate for forming second electrodes and second electrode lead terminals in a state that the second metal film covers the first electrodes and the insulation film;
a patterning step in which a photosensitive resist is applied to the formed second metal film and exposed portions of the second metal film are formed by exposure and developing processing of a pattern of the second electrodes and the second electrode lead terminals;
an etching processing step in which the exposed portions of the second metal film are etched and the photosensitive resist is removed after etching thus forming the second electrodes and the second electrode lead terminals; and
an insulation film removing step in which the insulation film in the sealing region which is sealed by a first electrode lead side of the sealing frame is removed.

11. A manufacturing method of a self-luminous planar display device according to claim 10, wherein the first metal film, the second metal film and the insulation film is formed by vapor deposition.

12. A manufacturing method of a self-luminous planar display device according to claim 10, wherein the removal of the insulation film is performed by dry etching.

13. A manufacturing method of a self-luminous planar display device which includes a display panel comprising;
a back panel which forms a large number of first electrodes which extend in the first direction and are arranged in parallel in the second direction which intersects the first direction and a large number of second electrodes which extend in the second direction and are arranged in parallel in the first direction on a back substrate;
a face panel which forms phosphor layers on a face substrate;
a sealing frame which seals the back panel and the face panel;
first electrode lead terminals which are pulled out to the outside from the first electrodes through a sealing region where the back substrate and the sealing frame face each other in an opposed manner; and
second electrode lead terminals which are pulled out to the outside from the second electrodes through the sealing region where the back substrate and the sealing frame face each other in an opposed manner; wherein
the manufacturing method comprises at least:
a first metal film forming step in which a first metal film is formed for forming the first electrodes and the first electrode lead terminals on the back substrate which constitutes the back panel;
a patterning step in which a photosensitive resist is applied to the formed first metal film and exposed portions of the first metal film are formed by exposure and developing processing of a pattern of the first electrodes and the first electrode lead terminals;
an etching processing step in which the exposed portions of the first metal film are etched and the photosensitive resist is removed after etching thus forming the first electrodes and the first electrode lead terminals;
an insulation film forming step in which an insulation film is formed in a state that an insulation film covers the first electrodes and the first electrode lead terminals and the insulation film is formed to reach the outside of a sealing region which is sealed by the sealing frame;
a second metal film forming step in which a second metal film is formed over the back substrate for forming second electrodes and second electrode lead terminals in a state that the second metal film covers the first electrodes and the first electrode lead terminals and the insulation film;
a patterning step in which a photosensitive resist is applied to the formed second metal film and exposed portions of the second metal film are formed by exposure and developing processing of a pattern of the second electrodes and the second electrode lead terminals;
an etching processing step in which the exposed portions of the second metal film are etched and the photosensitive resist is removed after etching thus forming the second electrodes and the second electrode lead terminals; and
an insulation film removing step in which the insulation film in spaces between the second electrode lead terminals in the sealing region which is sealed by the sealing frame is removed.

14. A manufacturing method of a self-luminous planar display device according to claim 13, wherein the first metal film, the second metal film an the insulation film are formed by vapor deposition.

15. A manufacturing method of a self-luminous planar display device according to claim 13, wherein the removal of the insulation film is performed by dry etching.
